(19) United States
(12) Patent Application Publication
(10) Pub. No.: US 2007/0127162 A1
(43) Pub. Date: Jun. 7, 2007

(54) MAGNETIC HEAD DEVICE PROVIDED WITH LEAD ELECTRODE ELECTRICALLY CONNECTED TO UPPER SHIELD LAYER AND LOWER SHIELD LAYER

(75) Inventors: Yoshihiro Nishiyama, Niigata-ken (JP); Daigo Aoki, Niigata-ken (JP); Toru Takahashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/567,573

(22) Filed: Dec. 6, 2006

(30) Foreign Application Priority Data
Dec. 6, 2005 (JP) 2005-351748

(51) Int. Cl. G11B 5/33; G11B 5/127

(52) U.S. Cl. 360/319; 360/322

(57) ABSTRACT

A lower shield layer and an upper shield layer are formed to have a planar shape, and a detecting element is provided between the lower shield layer and the upper shield layer. A lower conductive electrode is formed to adhere closely to a facing inner surface corresponding to a top surface of the lower shield layer, and an upper conductive electrode is formed to adhere closely to an outer surface located on the upper shield layer. Therefore, even though a facing interval between the lower shield layer and the upper shield layer is small, an electrical insulating property may be achieved.

This application claims the benefit of Japanese patent application number 2005-351748, filed on Dec. 6, 2005, which is hereby incorporated by reference herein.

### TECHNICAL FIELD

The present disclosure relates to a magnetic head device using a detecting element in which a current flows in a thicknesswise direction using a GMR effect or a tunnel effect. More particularly, the present disclosure relates to a magnetic head device in which a current path has a simple structure and an insulating effect is improved.

### BACKGROUND

Generally, for a magnetic head device using a detecting element that operates based on a GMR effect (giant magnetoresistive effect) or a tunnel effect, a sense current flows in a thicknesswise direction of the detecting element and the magnetic head is referred to as a current-perpendicular-to-the-plane (CPP)-type device.

The CPP-type magnetic head device includes a lower shield layer formed of a soft magnetic material on the bottom of a detecting element, and an upper shield layer formed of a soft magnetic material on the detecting element. A leakage magnetic flux from a magnetic recording medium in a middle region between both the lower shield layer and the upper shield layer is detected by the detecting element, so that magnetic information recorded on the magnetic recording medium may be read. To apply a current to the detecting element in a thicknesswise direction in this CPP-type magnetic head device, the detecting element may be electrically connected to the lower shield layer and the upper shield layer, and a current may be applied to the detecting element through the upper and lower shield layers.

However, according to the related art, a conductive layer (lead layer) that applies a current to a lower shield layer and an upper shield layer is generally provided at an inner side than a facing surface of a recording medium.

In a magnetic head device disclosed in JP-A-2001-307307, a portion of each of a lower shield layer and an upper shield layer continuously extends backward, which forms a conductive layer (lead layer). In a magnetic head device disclosed in JP-A-2002-25017 an upper shield layer and a lower shield layer are formed such that the lower shield layer has a larger area than the upper shield layer, and a rear portion of the lower shield layer extends backward more than a rear portion of the upper shield layer, via-hole conductors are provided on the lower and upper shield layers, and a conductive layer (lead layer) that is electrically connected to each via-hole conductor is provided on an insulating layer covering the lower shield layer.

The lower shield layer and the upper shield layer have a function of transmitting a magnetic flux from a recording medium, preventing the magnetic flux from leaking into a region other than the detecting element, and restricting a magnetic signal to be read by the detecting element in a linear direction. In recent years, in a recording medium such as a hard disk or the like, a recording density, a reproducing speed of a signal recorded on the recording medium, and a frequency of a reproducing signal have been increased. Therefore, due to a magnetic resistance effect (MR effect) of each of the lower shield layer and the upper shield layer, reading precision of the detecting element may be reduced or noise may overlap reading signals. For this reason, it is preferable that each of the lower shield layer and the upper shield layer have an area as small as possible and a simple shape.

In the magnetic head device disclosed in JP-A-2001-307307, the lower shield layer and the upper shield layer integrally extend backward, thereby forming a conductive layer. As a result, the lower shield layer and the upper shield layer have complicated planar shapes that may cause noise. Further, since each of the lower shield layer and the upper shield layer is formed of a soft magnetic material, such as an alloy of Ni.Fe (alloy of nickel and iron), a direct current resistance is high, and a detection output calculated from the resistance variation may be reduced.

In the magnetic head device disclosed in JP-A-2002-25017, since the lower shield layer is formed to have a larger size than the upper shield layer, it is likely to provide unbalanced shielding effects between the lower shield layer and the upper shield layer, which affects reading precision of the detecting element. Further, noise may occur due to the large and complicated shape of the lower shield layer. Furthermore, via-hole conductors are formed in the lower shield layer and the upper shield layer, and a lead layer that is electrically connected to the lower shield layer and a lead layer that is electrically connected to the upper shield layer are formed at locations higher than the upper shield layer. Thus, the size of the entire magnetic head device is increased.

### SUMMARY

A magnetic head device includes a lower shield layer comprising a soft magnetic material and an upper shield layer comprising a soft magnetic material, where the upper shield layer is disposed a predetermined distance from the lower shield layer. A detecting element is disposed between the lower shield layer and the upper shield layer, and a current is applied to the detecting element in a thicknesswise direction, such that the lower shield layer and the upper shield layer form a current path. A lower conductive electrode and an upper conductive electrode are electrically connected to the lower shield layer and the upper shield layer, respectively. The lower shield layer and the upper shield layer have facing inner surfaces disposed facing each other and outer surfaces disposed opposite to the facing inner surfaces, respectively, and the lower conductive electrode is disposed directly adjacent to the outer surface of the lower shield layer or the upper conductive electrode is disposed directly adjacent to the outer surface of the upper shield layer.

In the magnetic head device according to the present disclosure, even though the facing interval between the lower shield layer and the upper shield layer is small, an electrical insulating property between the lower conductive electrode and the upper shield layer, and an electrical insulating property between the upper conductive electrode and the lower shield layer may be sufficiently ensured. Since the interval between the lower shield layer and the upper shield layer may be decreased, it is possible to construct a small-gap-type magnetic head device. Further, since the lower shield layer and the upper shield layer may be flat and have a simple shape, it is possible to reduce noise occurring due to a magnetic resistance effect of the shield layers.

### BRIEF DESCRIPTION OF THE DRAWINGS

FIG. 1 is a partial sectional perspective view illustrating a magnetic head device according to a first embodiment;

FIG. 2 is a cross-sectional view of a magnetic head device taken along the line II-II of FIG. 1;

FIG. 3 is a cross-sectional view of a magnetic head device taken along the line III-III of FIG. 1;

FIG. 4 is a diagram illustrating a magnetic head device according to a second embodiment, which corresponds to a cross-sectional view illustrating the same portion as FIG. 2; and

FIG. 5 is a front view of a detecting element and a lower shield layer and an upper shield layer, when viewed from a facing side of a recording medium.

### DETAILED DESCRIPTION

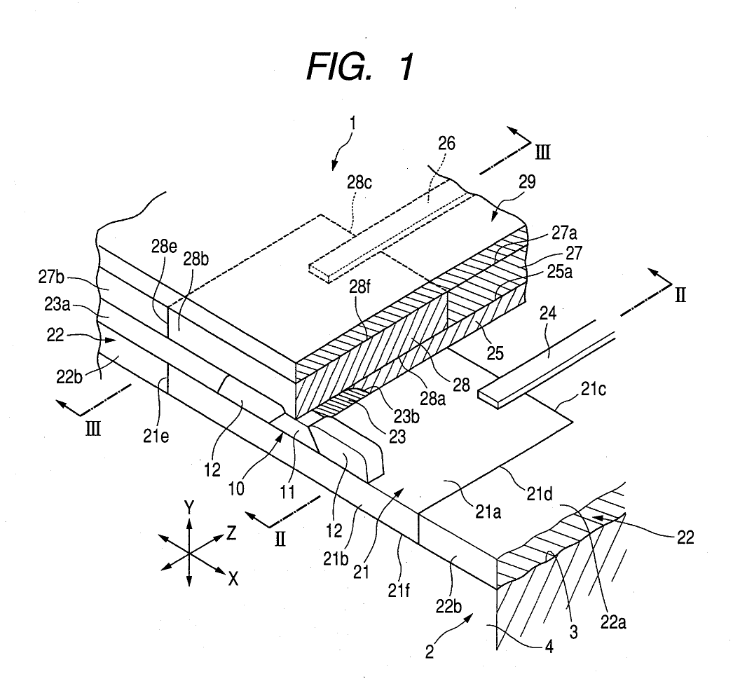

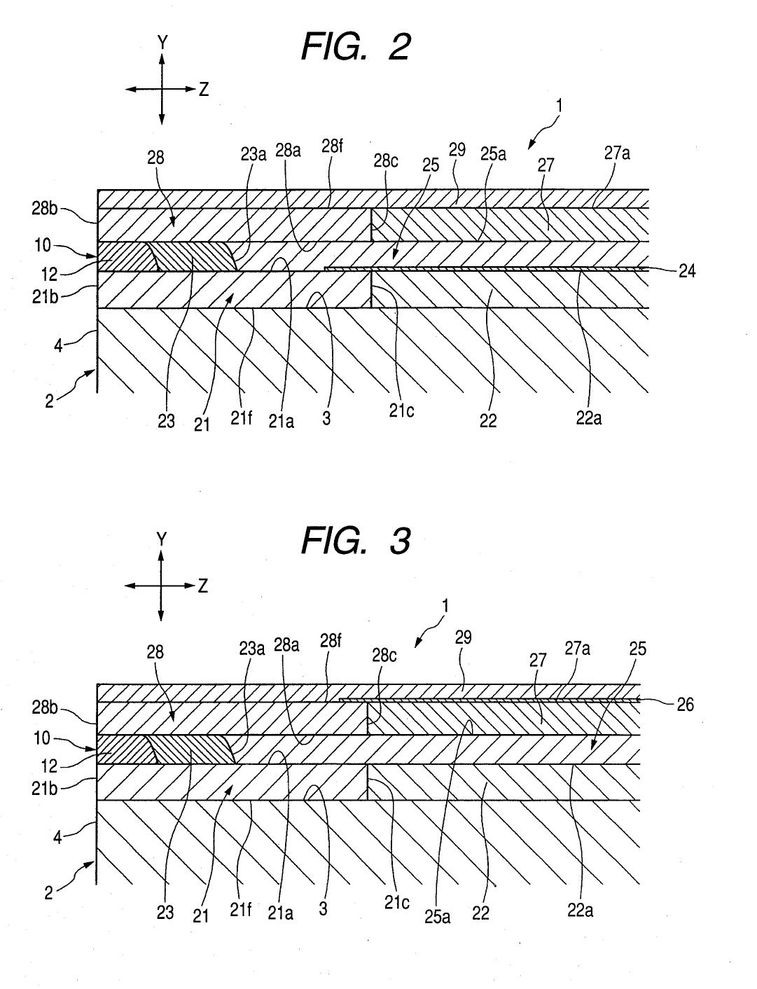

FIG. 1 is a partial sectional perspective view illustrating a magnetic head device according to a first embodiment. FIG. 2 is a cross-sectional view of a magnetic head device taken along the line II-II of FIG. 1. FIG. 3 is a cross-sectional view of a magnetic head device taken along the line III-III of FIG. 1. FIG. 5 is a front view of a detecting element and a lower shield layer and an upper shield layer, when viewed from a facing side of a recording medium.

A magnetic head device 1 is formed on a trailing-side end face 3 of a slider 2 by means of a thin film process. The slider 2 is formed of a ceramic material such as Al₂O₃.TiC (alumina and titanium carbide). A facing surface 4 is opposite to a magnetic recording medium, such as a hard disk or the like. In the slider 2, a surface opposite to the facing surface 4 is fixed to an elastically deformable flexure (not shown), and is supported by a front end of a supporter (not shown) called a load beam to be elastically deformable. When a recording medium rotates, the facing surface 4 floats from a surface of the recording medium due to an air flow (airbearing) between the surface of the recording medium and the facing surface 4, and a very small distance is obtained between the magnetic head device 1 and the surface of the recording medium. The leakage magnetic flux from a magnetic signal that is recorded on the recording medium is detected by the magnetic head device 1.

In FIGS. 1 to 3, a Y direction is the direction of motion of the recording medium, but is referred to as an upward and downward direction in the following description. Further, an X direction is a track widthwise direction of the magnetic signal recorded on the recording medium, but is referred to as a widthwise direction or a leftward and rightward direction in the below description. Furthermore, a Z direction is a direction in which a leakage magnetic flux from the recording medium flows, but is referred to as a depthwise direction or a forward and backward direction. Further, in the slider 2 for recording and reproducing, a magnetic head device for recording that is formed by a thin film process is formed to overlap a region on the magnetic head device 1, but the magnetic head for recording is not shown in FIG. 1.

A detecting element 10 is provided in the magnetic head device 1. FIG. 5 is a front view of the detecting element 10 when viewed from the Z direction. The detecting element 10 has a detecting unit 11 located at a central portion of the detecting element 10 in a widthwise direction (X direction), and bias units 12 that are respectively located at right and left sides of the detecting element 10.

As shown in FIG. 5, the detecting unit 11 includes an antiferromagnetic material layer 13, a pinned magnetic layer 14, a non-magnetic material layer 15, a free magnetic layer 16, and a protective layer 17, which are formed such that they sequentially overlie one another from a lower side (slider 2 side). Each of the antiferromagnetic material layer 13, the pinned magnetic layer 14, the non-magnetic material layer 15, the free magnetic layer 16, and the protective layer 17 is a thin film having a thickness measured in units of nm (nanometer) or units of Å (angstrom). The antiferromagnetic material layer 13 may be formed of, for example, an alloy of Ir.Mn (an alloy of iridium and manganese or IrMn alloy), or an alloy of Pt.Mn (alloy of platinum and manganese). The pinned magnetic layer 14 has a laminated ferrimagnetic structure in which a lower layer may be made of an alloy of Co.Fe (alloy of cobalt and iron or CoFe alloy), a middle layer may be made of Ru (ruthenium), and an upper layer may be made of an alloy of Co.Fe (CoFe alloy). The layers of the ferimagnetic structure overlie one another. Due to exchange-coupling between the antiferromagnetic material layer 13 and the lower layer preferably made of a CoFe alloy that adheres closely to the antiferromagnetic material layer 13, the magnetization direction of the lower layer is pinned in a depthwise direction (z direction Further, by an RKKY interaction through Ru, the magnetization direction of the upper layer preferably made of the CoFe alloy is fixed in a depthwise direction (Z direction) opposite to the magnetization direction of the lower layer.

When forming a CPP-GMR element making use of a giant magnetoresistance effect, the non-magnetic material layer 15 is a non-magnetic conductive layer, such as Cu (copper), and when forming a TMR element making use of a tunnel effect, the non-magnetic material layer 15 is a non-magnetic conductive layer, such as Al₂O₃. The free magnetic layer 16 may be formed of an alloy of Ni.Fe (NiFe alloy) or the like, and the protective layer 17 may be formed of a conductive metallic material, such as Ta or the like.

Each of the bias units 12 includes a hard magnetic material layer 18 that may be made of an alloy of Co.Pt (alloy of cobalt.platinum or CoPt alloy), a non-magnetic insulating layer 19a that is formed on the bottom of the hard magnetic material layer 18 and may be made of Al₂O₃ or the like, and a non-magnetic layer 19b that is formed on the hard magnetic material layer 18 and may be made of Ta or the like. By means of a coercive force in the soft magnetic material layer 18, the magnetization of the free magnetic layer 16 forms a single magnetic domain in a widthwise direction (X direction). The magnetization direction of the free magnetic layer 16 varies due to the leakage magnetic field from the recording medium, and an electrical resistance of the detecting unit 11 varies according to the relative relationship between the magnetization direction of the free magnetic layer 16 and a direction of pinned magnetization of the pinned magnetic layer 14. A sensing current is applied to the detecting unit 11 in a thicknesswise direction (Y direction). By detecting the variation in a voltage due to the variation in the sensing current and the electrical resistance, a signal of the leakage magnetic field from the recording medium may be detected.

As shown in FIGS. 1 to 3, according to a structure of the magnetic head device 1 according to the first embodiment, a lower shield layer 21 is provided on a trailing-side end face 3 of the slider 2. The lower shield layer 21 may be formed of a soft magnetic material, such as an alloy of Ni.Fe (NiFe alloy) or an alloy of Co.Fe (CoFe alloy), by using a plating process. Although not shown in the drawing, an insulating layer, which is made of a non-magnetic material, such as Al₂O₃, is formed on the trailing-side end face 3 of the slider 2, and a plating base film made of Ni or the like may be formed on the insulating layer by using a sputtering process. On the plating base film, the lower shield layer 21 may be formed by plating a soft magnetic alloy.

In the lower shield layer 21, a top surface is a facing inner surface 21a, and a bottom surface that is opposite to the facing inner surface 21a is an outer surface 21f. The facing inner surface 21a and the outer surface 21f are flat and are parallel to the trailing-side end face 3 of the slider 2. Further, a thickness of the lower shield layer 21 is substantially uniform over an entire region of the lower shield layer 21. A front side surface 21b of the lower shield layer 21 is on the same plane as the facing surface 4 of the slider 2, and an inner side surface 21c of the lower shield layer 21 is parallel to the front side surface 21b. A right side surface 21d and a left side surface 21e of the lower shield layer 21 are parallel to each other, and are perpendicular to the inner side surface 21c and the front side surface 21b. The planar shape of the lower shield layer 21 when viewed from an upper side of a Y direction is rectangular. The detecting element 10 is formed to adhere closely to the top surface 21a of the lower shield layer 21, and the lower shield layer 21 and the antiferromagnetic material layer 13 of the detecting unit 11 are electrically connected to each other.

A lower insulating layer 22 is formed at a portion closer to an inner side than the inner end face 21c of the lower shield layer 21, closer to a right outer side than the right end face 21d, and closer to a left outer side than the left end face 21e. The lower insulating layer 22 may be formed of a non-magnetic inorganic material, such as Al₂O₃ or SiO₂, by using a sputtering process. The top surface 22a of the lower insulating layer 22 and the facing inner surface 21a of the lower shield layer 21 are formed on the same plane. Further, a front side surface 22b of the lower insulating layer 22 is formed on the same plane as the facing surface 4 of the slider 2 and the front side surface 21b of the lower shield layer 21.

As shown in FIGS. 1, 2, and 3, on an inner side of the detecting unit 11 and the bias units 12 and 12 that form the detecting element 10, a first insulating layer 23 may be formed of a non-magnetic inorganic material, such as Al₂O₃ or SiO₂, by using a sputtering process. A rear edge portion 23b of the first insulating layer 23 extends backward to be closer to an inner side than the detecting element 10. Further, the first insulating layer 23 is formed even in right and left side portions of the detecting element 10, and the front side surface 23a of the first insulating layer 23 is formed on the same plane as the facing surface 4 of the slider 2 at right and left sides of the detecting element 10.

As shown in FIGS. 1 and 2, a lower conductive electrode 24 is provided on the lower shield layer 21. The lower conductive electrode 24 is made of a conductive material that has a smaller specific resistance than a soft magnetic material forming the lower shield layer 21. Specifically, the lower conductive electrode 24 is formed of a material, such as Cu (copper), Au (platinum), W (tungsten), or the like. The lower conductive electrode 24 may be formed by using a plating process or a sputtering process. The lower conductive electrode 24 has a predetermined width in a region ranging from the top surface 21a of the lower shield layer 21 to the top surface 22a of the lower insulating layer 22, and the top surface 21a of the lower shield layer 21 and the top surface 22a of the lower insulating layer 22 are formed on the same plane. The lower conductive electrode 24 is formed to directly come into contact with the top surface 21a of the lower shield layer 21, and extends backward more than the inner side surface 21c of the lower shield layer 21.

Behind the first insulating layer 23, a second insulating layer 25 is formed. The second insulating layer 25 may be formed of a non-magnetic inorganic material, such as Al₂O₃ or SiO₂, by using a sputtering process. Further, the second insulating layer 25 is formed on the top surface 21a of the lower shield layer 21 and the top surface 22a of the lower insulating layer 22 with a predetermined thickness. The lower conductive electrode 24 is covered by the second insulating layer 25. Further, the second insulating layer 25 is connected to a rear edge portion 23b of the first insulating layer 23. As shown in FIGS. 2 and 3, according to this embodiment, the thickness of the second insulating layer 25 is substantially the same as that of the first insulating layer 23. However, the thickness of the second insulating layer 25 may be equal to or smaller than that of the first insulating layer 23.

An upper shield layer 28 is provided on the top surface 25a of the second insulating layer 25. The upper shield layer 28 may be formed of the same soft magnetic material as the lower shield layer 21 by using a plating process. That is, a plating base film made of Ni or the like may be formed by using a sputtering method, and a soft magnetic material may be deposited on the plating base film by plating to form the upper shield layer 28.

The upper shield layer 28 is formed to be parallel to the lower shield layer 21 at a predetermined interval in a Y direction together with the lower shield layer 21. That is, the facing inner surface 28a that is a bottom surface of the upper shield layer 28 and an outer surface 28f that is a top surface opposite to the facing inner surface 28a are parallel to the facing inner surface 21a of the lower shield layer 21, and the thickness of the upper shield layer 28 is substantially uniform over an entire region of the upper shield layer 28.

The front side surface 28b of the upper shield layer 28 is located on the same plane as the front side surface 21b of the lower shield layer 21. At an inner side of the front side surface 21b, the facing inner surface 21a adheres closely to a protective film 17 of the detecting unit 11, and the upper shield layer 28 and the detecting unit 11 are electrically connected to each other.

The inner end face 28c of the upper shield layer 28 is parallel to the front side surface 28b and also located at the same inner location as the inner end face 21c of the lower shield layer 21. The left end face 28e and the right end face of the upper shield layer 28 are perpendicular to the front side surface 28b and the inner end face 28c. The left end face 28e of the upper shield layer 28 is formed at the same location as the left end face 21e of the lower shield layer 21, and the right end face of the upper shield layer 28 is formed at the same location as the right end face 21d of the lower shield layer 21. The upper shield layer 28 and the lower shield layer 21 have the same planar rectangular shape. In addition, areas of the planar rectangular shapes of the upper shield layer 28 and the lower shield layer 21 are equal to each other.

A third insulating layer 27 is formed behind, or at an inner side of, the inner end face 28c of the upper shield layer 28, at an outer side in a rightward direction than the left end face 28e of the upper shield layer 28, and at an outer side than the right end face. The third insulating layer 27 may be formed of the same inorganic material as the first insulating layer 23 or the second insulating layer 25. The top surface 27a of the third insulating layer 27 is formed on the same surface as the outer surface 28f of the upper shield layer 28. Further, the front side surface 27b of the third insulating layer 27 appears on the same surface as the facing surface 4 at outer sides of the upper shield layer 28 in right and left directions.

As shown in FIG. 3, an upper conductive electrode 26 is formed on the outer surface 28f of the upper shield layer 28 and the top surface 27a of the third insulating layer 27. The upper conductive electrode 26 may be formed of the same material as the lower conductive electrode 24 by using a process of the same kind as a process of forming the lower conductive electrode 24. The upper conductive electrode 26 adheres closely to the outer surface 28f of the upper shield layer 28, and a rear end portion of the upper conductive electrode 26 extends by a predetermined length toward an inner side away from the facing surface 4 along the top surface 27a of the third insulating layer 27. That is, behind the inner end face 21c of the lower shield layer 21 and behind the inner end face 28c of the upper shield layer 28, the lower conductive electrode 24 and the upper conductive electrode 26 are parallel to each other and extend linearly by a predetermined distance toward the inner side, in a state where the lower conductive electrode 24 and the upper conductive electrode 26 interpose the second insulating layer 25 and the third insulating layer 27 therebetween.

An upper insulating layer 29 is formed on the upper shield layer 28 and the third insulating layer 27. The upper insulating layer 29 may be formed of the same material as the lower insulating layer 22, the first insulating layer 23, the second insulating layer 25, and the third insulating layer 27 by using a process of the same type. Further, a magnetic head device for recording is formed on the upper insulating layer 29 so as to overlap it. As shown in FIG. 3, the upper conductive electrode 26 is covered with the upper insulating layer 29.

In the magnetic head device 1, only the lower conductive electrode 24 is provided between the facing inner surface 21a of the lower shield layer 21 and the facing inner surface 28a of the upper shield layer 28. The lower conductive electrode 24 adheres closely to the facing inner surface 21a of the lower shield layer 21, and the lower conductive electrode 24 and the upper shield layer 28 are insulated from each other by the second insulating layer 25. Further, the upper conductive electrode 26 is not inserted in a facing region of the lower shield layer 21 and the upper shield layer 28 and it is formed to adhere closely to the outer surface 28f of the upper shield layer 28.

In the magnetic head device 1, a current flows through a path of the lower conductive electrode 24, the lower shield layer 21, the detecting unit 11, the upper shield layer 28, and the upper conductive electrode 26, and in the detecting unit 11, a current flows in a thickness direction thereof (Y direction).

The lower conductive electrode 24 is formed at a middle location between the lower shield layer 21 and the upper shield layer 28, and extends behind the inner end face 21c of the lower shield layer 21. The upper conductive electrode 26 adheres closely to the outer surface 28f of the upper shield layer 28 and extends by a predetermined distance backward further than the inner end face 28c of the upper shield layer 28. For this reason, a structure for deforming the lower shield layer 21 and the upper shield layer 28 and extracting a current to the outside does not need to be provided, so that each of the lower shield layer 21 and the upper shield layer 28 may have a simple shape, such as a rectangular shape, and a flat shape.

Further, the lower conductive electrode 24 adheres closely to the lower shield layer 21 so as to be two-dimensionally formed, and the upper conductive electrode 26 adheres closely to the upper shield layer 28 to be dimensionally formed. Therefore, it is not required that a bump or the like extends from the lower shield layer 21 or the upper shield layer 28 so as to form a current path. Since a current supply path may not exist above the upper conductive electrode 26 that adheres closely to the outer surface 28f of the upper shield layer 28, when the magnetic head device for recording is formed on the upper insulating layer 29 by using a thin film process, a current supply path to the lower and upper shield layers 21 and 28 may not hinder lamination of the magnetic head device for recording. For this reason, the lower shield layer 21 and the upper shield layer 28 may not need to be formed to extend to the inner side (side spaced apart from the facing surface 4). Therefore, the inner end face 21c of the lower shield layer 21 and the inner end face 28c of the upper shield layer 28 can be disposed at locations close to the facing surface 4, which reduces the respective areas of the lower shield layer 21 and the upper shield layer 28.

Further, all of the lower shield layer 21 and the upper shield layer 28 may have a rectangular shape. When the lower shield layer 21 and the upper shield layer 28 are viewed from an upper side of the Y direction, the planar shape of the upper shield layer 28 and the planar shape of the lower shield layer 21 may be rectangular and flat. Accordingly, the shapes are not complicated.

Since the lower shield layer 21 and the upper shield layer 28 are formed of a soft magnetic material, such as a NiFe alloy or CoFe alloy, they show a magnetoresistance effect. The lower shield layer 21 and the upper shield layer 28 can be formed as small as possible, and the shapes thereof can be simplified, which suppresses noise from occurring due to magnetoresistance effects of the lower shield layer 21 and the upper shield layer 28. Further, since all of the lower shield layer 21 and the upper shield layer 28 have the small size and the simple structure, when the upper and lower shield layers are formed, it may be possible to avoid a plating defect. Further, it may be possible to effectively achieve a shielding effect of the lower shield layer 21 and the upper shield layer 28.

Further, as shown in FIG. 3, since the upper conductive electrode 26 is disposed at a location spaced apart from the lower shield layer 21, it may be possible to ensure an electrical insulating property between the upper conductive electrode 26 and the lower shield layer 21. Further, since the lower conductive electrode 24 adheres closely to the facing inner surface 21a of the lower shield layer 21, an electrical insulating property between the lower conductive electrode 24 and the upper shield layer 28 can be sufficiently ensured by the second insulating layer 25 that is located between the lower shield layer 21 and the upper shield layer 28.

Accordingly, even though an interval between the facing inner surface 21a of the lower shield layer 21 and the facing inner surface 28a of the upper shield layer 28 in a Y direction is small, an electrical insulating property between the lower conductive electrode 24 and the upper shield layer 28, and an electrical insulating property between the lower shield layer 21 and the upper conductive electrode 26 may be achieved. That is, the facing interval between the flat lower shield layer 21 and the flat upper shield layer 28 may be made to be small, such that the lower and upper shield layers 21 and 28 can come into contact with a bottom surface and a top surface of a small-sized detecting unit 11. As a result, the magnetic head device 1 may be constructed to have a small size, and a magnetic head device having a small gap may be constructed. Further, since each of the lower and upper shield layers 21 and 28 has a small size and a flat shape, noise generated by the lower and upper shield layers 21 and 28 may be reduced.

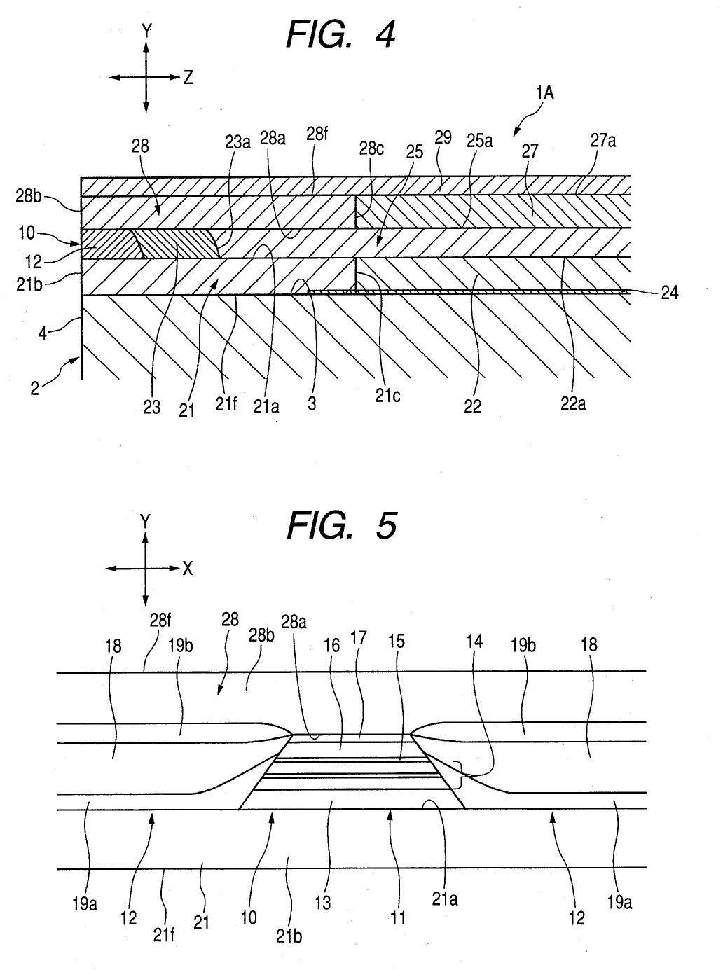

FIG. 4 is a partial sectional perspective view illustrating a magnetic head device 1A according to a second embodiment, which corresponds to the cross-sectional view of FIG. 2 (cross-sectional view taken along the line II-II of FIG. 1). The magnetic head device 1A according to the second embodiment shown in FIG. 4 is the same as the magnetic head device 1 according to the first embodiment shown in FIGS. 1 to 3, except for a sectional structure shown in FIG. 4. Therefore, the same constituent elements as those of the magnetic head device 1 according to the first embodiment are denoted by the same reference numerals, and the description thereof will be omitted.

In the magnetic head device 1A, the lower conductive electrode 24 is formed at a lower portion of the lower shield layer 21 and the lower insulating layer 22. As described above, the insulating layer, which may be formed of a material made of Al₂O₃ or SiO₂, is provided on the trailing-side end face 3 of the slider 2. The lower conductive electrode 24 is formed on the insulating layer, and the lower shield layer 21 and the lower insulating layer 22 are formed on the lower conductive electrode 24. The lower conductive electrode 24 and the outer surface 21f of the lower shield layer 21 adhere closely to each other.

In the magnetic head device 1A, the lower conductive electrode 24 adheres closely to the outer surface 21f of the lower shield layer 21, the upper conductive electrode 26 adheres closely to the outer surface 28f of the upper shield layer 28, and neither the lower conductive electrode 24 nor the upper conductive electrode 26 is disposed in the facing region between the lower shield layer 21 and the upper shield layer 28. Therefore, even though a facing interval between the lower shield layer 21 and the upper shield layer 28 is small, an electrical insulating property may be achieved. By reducing a facing interval between the lower shield layer 21 and the upper shield layer 28, it is possible to construct a magnetic head device having a small gap and a small size.

Further, in contrast to the structure of the magnetic head device shown in FIGS. 1 to 3, the lower conductive electrode 24 may adhere closely to the outer surface 21f of the lower shield layer 21, and the upper conductive electrode 26 may adhere closely to the facing inner surface 28a of the upper shield layer 28.

1. A magnetic head device comprising:
a lower shield layer comprising a soft magnetic material;
an upper shield layer comprising a soft magnetic material and disposed a predetermined distance from the lower shield layer;
a detecting element disposed between the lower shield layer and the upper shield layer, a current being applied to the detecting element in a thicknesswise direction, the lower shield layer and the upper shield layer forming a current path; and
a lower conductive electrode and an upper conductive electrode electrically connected to the lower shield layer and the upper shield layer, respectively,
wherein the lower shield layer and the upper shield layer comprise facing inner surfaces disposed facing each other and outer surfaces disposed opposite of the facing inner surfaces, respectively, and
the lower conductive electrode is disposed directly adjacent to the outer surface of the lower shield layer or the upper conductive electrode is disposed directly adjacent to the outer surface of the upper shield layer.

2. The magnetic head device according to claim 1,
wherein the lower conductive electrode is disposed directly adjacent to the outer surface of the lower shield layer and the upper conductive electrode is disposed directly adjacent to the facing inner surface of the upper shield layer, or the upper conductive electrode is disposed directly adjacent to the outer surface of the upper shield layer and the lower conductive electrode is disposed directly adjacent to the facing inner surface of the lower shield layer.

3. The magnetic head device according to claim 1,
wherein the lower conductive electrode is disposed directly adjacent to the outer surface of the lower shield layer, and
the upper conductive electrode is disposed directly adjacent to the outer surface of the upper shield layer.

4. The magnetic head device according to claim 3,
wherein the lower conductive electrode and the upper conductive electrode are not disposed in a facing region between the lower shield layer and the upper shield layer.

5. The magnetic head device according to claim 1,
wherein the facing inner surface of the lower shield layer and the facing inner surface of the upper shield layer are planar and parallel to each other.

6. The magnetic head device according to claim 1,
wherein the lower shield layer and the upper shield layer have a same planar shape and a same area in the plane.

7. The magnetic head device according to claim 1, wherein the soft magnetic material of the upper shield layer is the same as the soft magnetic material of the lower shield layer.
